(19) United States
(12) Patent Application Publication
(10) Pub. No.: US 2011/0214292 A1
(43) Pub. Date: Sep. 8, 2011

(54) ELECTRIC SCISSORS HAVING A REPLACEABLE BLADE

(76) Inventor: Moon HEH, Taipei (TW)

(21) Appl. No.: 12/716,264

(22) Filed: Mar. 2, 2010

(51) Int. Cl. B26B 15/00; B26B 13/04

(52) U.S. Cl. 30/228; 30/260

(57) ABSTRACT

An electric scissors has a body and a changeable shear. The body has a stationary shear and an oscillating blade holder. The stationary shear has an arm and a first blade. The arm is formed on and protrudes outwardly from a front end of the body. The first blade is securely mounted on the arm. The oscillating blade holder is pivotally mounted to the front end of the body to oscillate relative to the stationary shear, and has a rail formed on the oscillating blade holder. The changeable shear has a blade seat and a second blade. The blade seat has a channel detachably and slidably engaging the rail of the oscillating blade holder. The second blade is securely mounted on the blade seat to obliquely abut the first blade. With the replaceable blade, the electric scissors can be continuously used without discarding the whole electric scissors when the blade is dull or damaged.

### BACKGROUND OF THE INVENTION

1. Field of the Invention

The present invention is related to an electric scissors, and more particularly to an electric scissors having a replaceable blade.

2. Description of the Related Art

When cutting things like papers, cloths and the like, knives and scissors could be useful tools to choose. A pair of scissors has two blades and is more appropriate for accurately cutting objects, such as manicures or hairs. Cutting heavy and thick things may be a strenuous job especially when such cutting needs to be repeated and an electric scissors is ideal for such situation. To continuously operate electric scissors, the first thing comes to mind is that electric scissors must have sufficient power to drive the electric scissors operating. Usually, the power of electric scissors is supplied by battery. Once the power is out, to replace the dead battery is necessary. The rest of concern is that the blades of any scissors surely become dull after a term of use. In the case of a pair of regular scissors, the blades the scissors can be sharpened again by a grindstone. However, a conventional electric scissors is not made for being repeatedly sharpened. When any blade of the scissors is dull, the electric scissors may be discarded and to get a new one is necessary since the blades of the conventional electric scissors are not replaceable.

### SUMMARY OF THE INVENTION

An objective of the present invention is to provide an electric scissors having a changeable shear to prolong the life span of the scissors by replacing a damaged blade with a new one.

To achieve the foregoing objective, the electric scissors has a body and a changeable shear.

The body has a stationary shear and an oscillating blade.

The stationary blade has an arm and a first blade. The arm is formed on and protrudes outwardly from a front end of the body. The first blade is securely mounted on the arm.

The oscillating blade holder is pivotally mounted on the front end of the body to oscillate relative to the stationary shear, and has a rail and a changeable shear. The rail is formed on a front portion of the oscillating blade holder. The changeable shear has a blade seat and a second blade. The blade seat has a channel defined in the blade seat and detachably and slidably engaging the rail of the oscillating blade holder. The second blade is securely mounted on the blade seat to obliquely abut the first blade.

With the replaceable blade, to discard the whole electric scissors is unnecessary if the blade is getting dull or damaged. Accordingly, the life span of the electric scissors can be prolonged.

### BRIEF DESCRIPTION OF THE DRAWINGS

FIG. 1 is a perspective view of a first preferred embodiment of an electric scissors in accordance with the present invention;

FIG. 2 is an exploded perspective view of the electric scissors in FIG. 1;

FIG. 3 is an enlarged partially exploded perspective view of the detachable blade of the electric scissors in FIG. 1;

FIG. 4 is a cross-sectional side view of the first preferred embodiment of an oscillating blade holder and a changeable shear of an electric scissors in accordance with the present invention;

FIG. 5 is a cross-sectional side view of a second preferred embodiment of an oscillating blade holder and a changeable shear of an electric scissors in accordance with the present invention;

FIG. 6 is a side view in partial section of the electric scissors in FIG. 1; and

FIG. 7 is an operational side view in partial section of the electric scissors in FIG. 1.

### DETAILED DESCRIPTION OF THE INVENTION

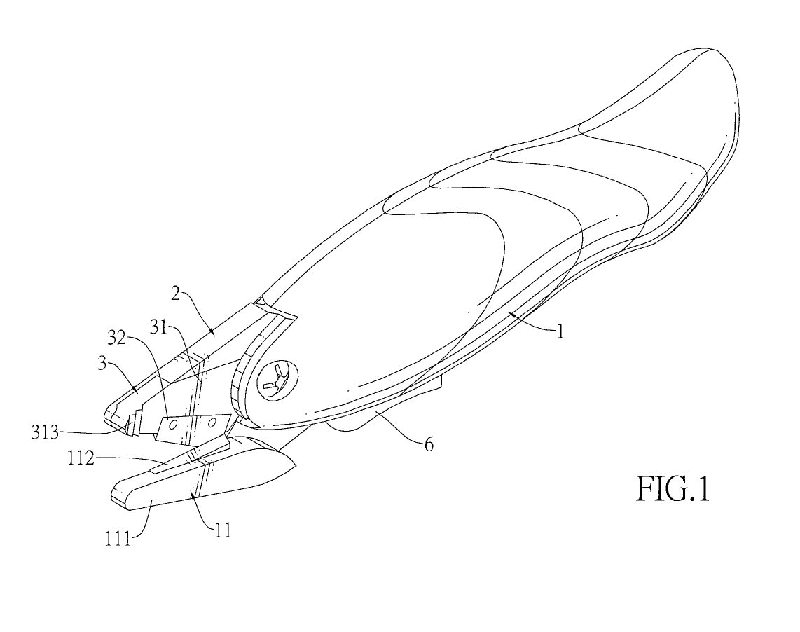

With reference to FIGS. 1 to 3, an electric scissors in accordance with the present invention has a body (1), an oscillating blade holder (2), a changeable shear (3), at least one battery (4), a motor (5), a button (6) and a gear set (7). The body (1) has a stationary shear (11). The stationary shear (11) has an arm (111) and a first blade (112). The arm (111) is formed on and protrudes outwardly from a front end of the body (1). The first blade (112) is securely mounted on the arm (111). The oscillating blade holder (2) is pivotally mounted on the front end of the body (1), can oscillate relative to the stationary shear (11) and has a rail (21) and a notch (22). The rail (21) is formed on a front portion of the oscillating blade holder (2), and the notch (22) is formed through a rear portion of the oscillating blade holder (2).

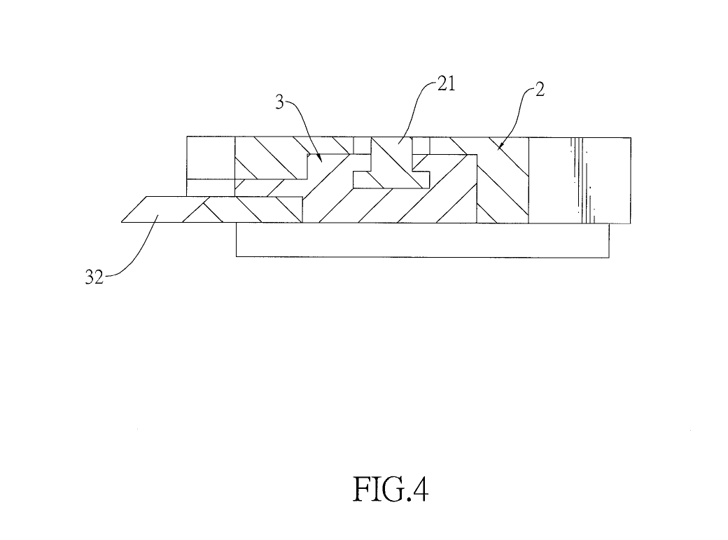

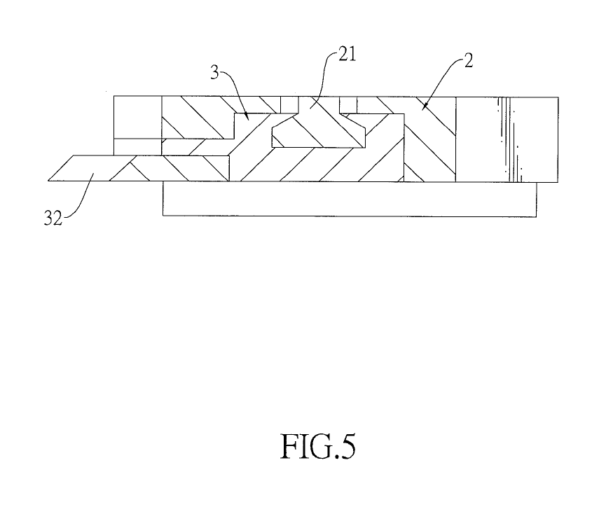

The changeable shear (3) has a blade seat (31) and a second blade (32). The blade seat (31) has a channel (311) defined in the blade seat (31) and detachably and slidably engaging the rail (21) of the oscillating blade holder (2). The second blade (32) is securely mounted on the blade seat (31) to obliquely abut the first blade (112). With reference to FIG. 4, the rail (21) on the oscillating blade holder (2) and the channel (311) in the changeable shear (3) may have a T-shaped cross section. With reference to FIG. 5, the rail (21) on the oscillating blade holder (2) is a dovetail-shaped rail, and the channel (311) in the changeable shear (3) is a dovetail-shaped channel.

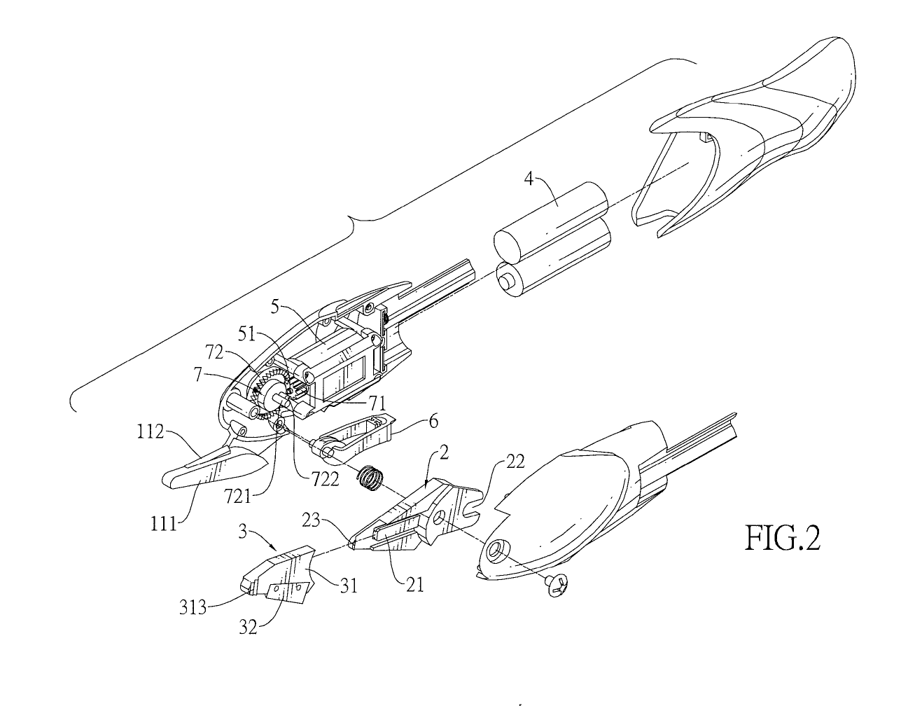

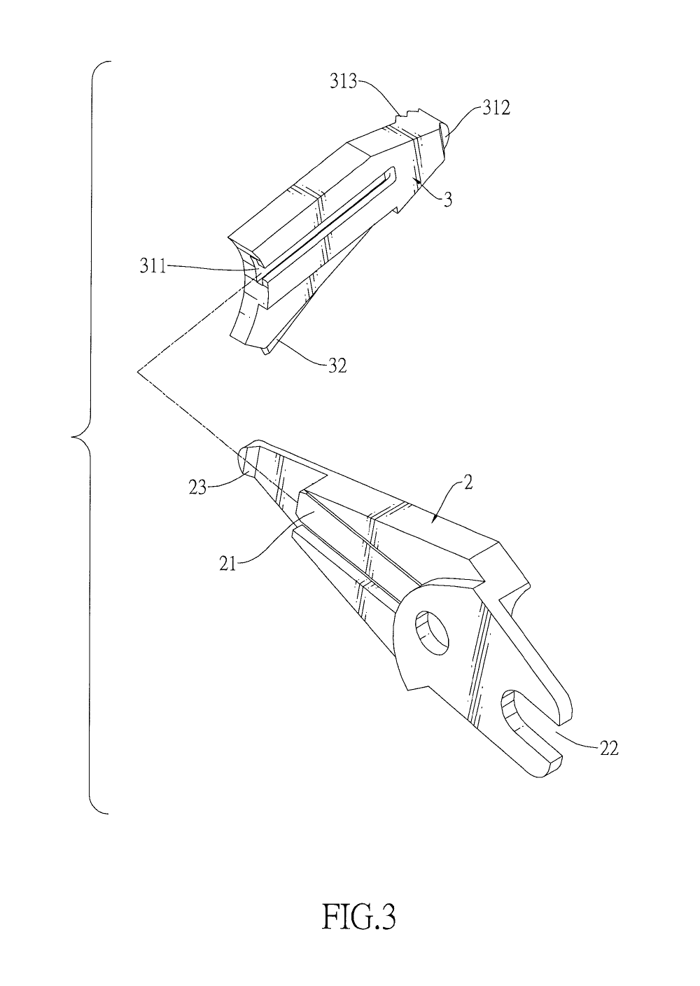

With reference to FIGS. 2 and 3, the oscillating blade holder (2) further has a stop (23) formed on and protruding from a front end of the oscillating blade holder (2). The blade seat (31) further has a recess (312) formed in a bottom of a front end of the blade seat (31) to engage the stop (23) of the oscillating blade holder (2). With the engagement between the stop (23) and the recess (312), the blade seat (31) can be securely held on and be kept from escaping from the oscillating blade holder (2). The blade seat (31) further has an undulated tip (313) formed on a top of the front end of the blade seat (31) for users to pinch and pull the blade seat (31) relative to the blade holder (2) easily.

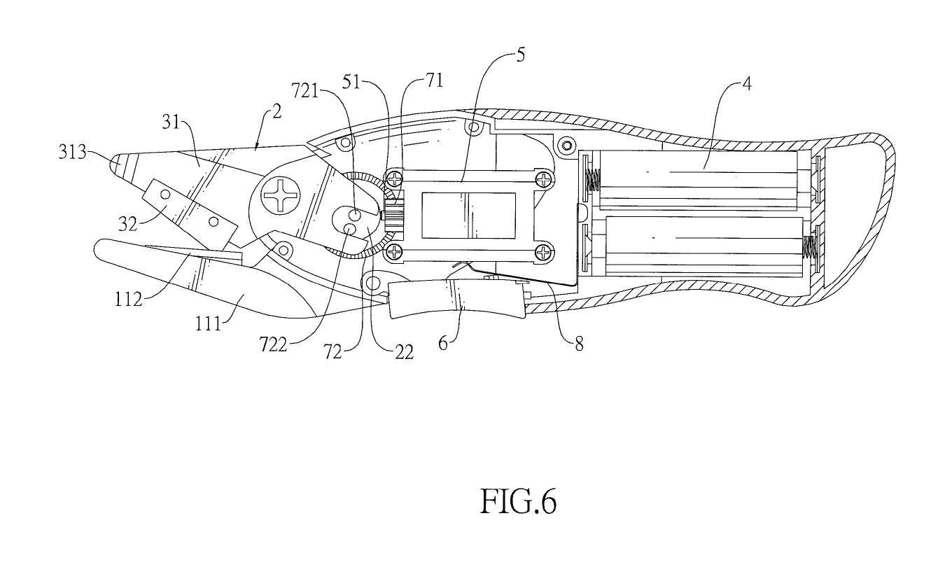

With further reference to FIG. 6, since the at least one battery (4), the motor (5), the button (6), the gear set (7) and a spring leaf (8) may be conventional and are known to the one skilled in the art, they is briefly described as follows. The at least one battery (4) is mounted in the body (1). In the preferred embodiment, two batteries are implemented. The motor (5) is mounted inside the body (1) and has a spindle (51). The spring leaf (8) is L-shaped and mounted inside the body (1). One end of the spring leaf (8) is electrically connected with the at least one battery (4) and the other end selectively abuts the motor (5). The button (6) is pivotally mounted on the body (1) and near the spring leaf (8). When the button (6) being pressed, the button (6) pushes the spring leaf (8) to electrically connect the motor (5) with the at least one battery (4) and the motor (5) is driven. When the button (6) being released, the button (6) is pivoted to the original position by with the force provided by the spring leaf (8) to electrically disconnect the motor (5) from the at least one battery (4) and the motor (5) is stopped. The gear set (7) has a pinion (71) and a gear (72). The pinion (71) is mounted on and driven by the spindle (51) of the motor (5). The gear (72) engages and is driven by the pinion (71), and has a central shaft (721) and an eccentric shaft (722) formed on the gear (72). The central shaft (721) and the eccentric shaft (722) are held within the notch (22) of the oscillating blade holder (2) to drive the oscillating blade holder (2) to oscillate when the gear (82) is rotating.

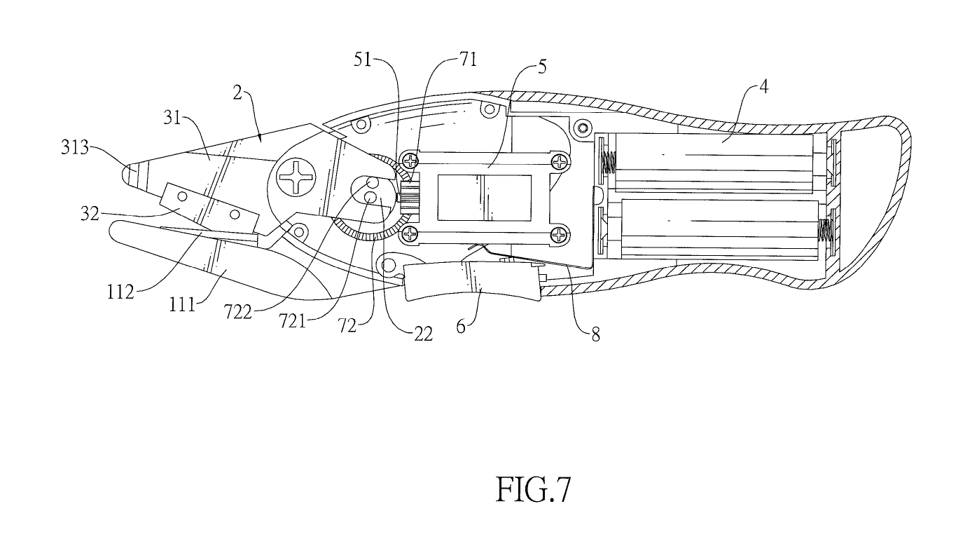

With reference to FIGS. 6 and 7, the oscillating blade holder (2) is driven to oscillate between two extreme positions respectively away from and near the stationary shear (11). With the oscillation of the changeable shear (3), objects, such as papers, clothes, foams and the like, can be cut by the first blade (112) and the second blade (32).

With such an arrangement, when the second blade (32) is damaged, the blade seat (31) with the damaged second blade (32) can be detached from the oscillating blade holder (2) and another blade seat (31) with a new blade (32) can be attached to the oscillating blade holder (2). Accordingly, the electric scissors can be continuously used without discarding the whole electric scissors when the second blade (32) is damaged. Consequently, cost of using the electric scissors can be reduced, and the life span of the electric scissors can be prolonged. Moreover, waste arising from the disposal of the electric scissors and deteriorating our environmental protection can be avoided.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An electric scissors comprising:
a body having
a stationary shear having
an arm formed on and protruding outwardly from a front end of the body; and
a first blade securely mounted on the arm;
an oscillating blade holder pivotally mounted on the front end of the body to oscillate relative to the stationary shear, and having a rail formed on a front portion of the oscillating blade holder; and
a changeable shear having
a blade seat having a channel defined in the blade seat and detachably and slidably engaging the rail of the oscillating blade holder; and
a second blade securely mounted on the blade seat to obliquely abut the first blade.

2. The electric scissors as claimed in claim 1, wherein the oscillating blade holder further comprises a stop formed on and protruding from a front end of the oscillating blade holder.

3. The electric scissors as claimed in claim 2, wherein the changeable shear further comprises:
an undulated tip formed on a top of a front end of the blade seat; and
a recess formed in a bottom of the front end of the blade seat to engage the stop of the oscillating blade holder.

4. The electric scissors as claimed in claim 1, wherein the rail of the oscillating blade holder and the channel of the changeable shear have a T-shaped cross section.

5. The electric scissors as claimed in claim 2, wherein the rail of the oscillating blade holder and the channel of the changeable shear have a T-shaped cross section.

6. The electric scissors as claimed in claim 3, wherein the rail of the oscillating blade holder and the channel of the changeable shear have a T-shaped cross section.

7. The electric scissors as claimed in claim 1, wherein the rail of the oscillating blade holder is a dovetail-shaped rail, and the channel of the changeable shear is a dovetail-shaped channel.

8. The electric scissors as claimed in claim 2, wherein the rail of the oscillating blade holder is a dovetail-shaped rail, and the channel of the changeable shear is a dovetail-shaped channel.

9. The electric scissors as claimed in claim 3, wherein the rail of the oscillating blade holder is a dovetail-shaped rail, and the channel of the changeable shear is a dovetail-shaped channel.

10. The electric scissors as claimed in claim 1, wherein the oscillating blade holder has a notch formed through a rear portion of the oscillating blade holder.

11. The electric scissors as claimed in claim 10, further comprising:
at least one battery received in the body;
a motor mounted inside the body and having a spindle;
a spring leaf mounted inside the body to electrically connect with the at least one battery and selectively abut the motor;
a button pivotally mounted on the body and near the spring leaf to push the spring leaf to electrically connect the motor with the at least one battery when the button is pressed, and to restore the spring leaf to electrically disconnect the motor from the at least one battery when the button is released; and
a gear set having
a pinion mounted on and driven by the spindle of the motor; and
a gear engaging and driven by the pinion, having a central shaft and an eccentric shaft held within the notch of the oscillating blade holder and driving the oscillating blade holder to oscillate when the gear is rotating.
